(19) United States
(12) Patent Application Publication
(10) Pub. No.: US 2026/0121346 A1
(43) Pub. Date: Apr. 30, 2026

(54) CONNECTOR MEMBER INCLUDING UNLOCKING MECHANISM AND CONNECTOR DEVICE USING CONNECTOR MEMBER

(71) Applicant: HIROSE ELECTRIC CO., LTD., Kanagawa (JP)

(72) Inventor: Junya IGA, Kanagawa (JP)

(21) Appl. No.: 19/367,028

(22) Filed: Oct. 23, 2025

(30) Foreign Application Priority Data
Oct. 24, 2024 (JP) 2024-187169

(51) Int. Cl. H01R 13/629; H01R 13/627; H01R 24/20

(52) U.S. Cl. CPC H01R 13/62972; H01R 13/6272; H01R 24/20

(57) ABSTRACT

A connector member including an unlocking mechanism, the connector member includes: a base that is attachable, on one end side in a length direction, to a connector main body having an elastic locking piece for locking, which protrudes in a cantilever shape; a manipulation lever that is pivotally supported on an outer surface of the base in a see-saw movable state and extends in the length direction; and a release lever that is pivotally supported on an outer surface of the base in a see-saw movable state and extends in the length direction.

### CROSS-REFERENCE TO RELATED APPLICATION

This application claims priority from Japanese Patent Application No. 2024-187169 filed with the Japan Patent Office on October 24, 2024, the entire content of which is hereby incorporated by reference.

### BACKGROUND

### 1. Technical Field

The present disclosure relates to a connector member including an unlocking mechanism and a connector device using the connector member.

### 2. Related Art

Some connectors, such as modular jacks used for connecting electronic devices, are equipped with an anti-disengagement lock lever. The lock lever is a lever used for engaging with a part of a receiver (jack) that receives the connector to place the connector in a locked state with respect to the receiver when connected to the electronic device, and this locked state can be released by pushing down the lock lever.

EP 4,312,322 A relates to an unlocking mechanism used for the connector having the lock lever described above, the unlocking mechanism being capable of pushing down the lock lever even in a situation where it is difficult to operate the lock lever due to a small protruding amount of a connection plug 1 from a housing 4 of a communication device or an automation device integrated with a connection socket 3. The unlocking mechanism includes an actuating element 100 that actuates on the locking tab 13, the actuating element 100 further including a first deflection lever 101 and a second deflection lever 102 rotatable about rotation axes 110 and 120 transversely to a longitudinal axis 10 of the connection plug 1. The first deflection lever 101 is coupled at a first end to a spring-loaded locking tab 13 and at a second end to a first end of the second deflection lever 102 using a hinge. The second deflection lever 102 can move the second end toward the longitudinal axis 10 of the connection plug 1 by applying a force, and in response to this motion, the first end of the hinged second deflection lever 102 and the second end of the first deflection lever 101 pivot in the direction moving away from the longitudinal axis 10 of the connection plug 1. As a result, the first end of the first deflection lever 101 moves toward the longitudinal axis 10 of the connection plug 1, acting on and unlocking the locking tab 13.

### SUMMARY

A connector member including an unlocking mechanism according to the present disclosure and a connector device using the connector member include: a base that is attachable, on one end side in a length direction, to a connector main body having an elastic locking piece for locking, which protrudes in a cantilever shape; a manipulation lever that is pivotally supported on an outer surface of the base in a see-saw movable state and extends in the length direction; and a release lever that is pivotally supported on an outer surface of the base in a see-saw movable state and extends in the length direction, in which the manipulation lever includes a manipulation portion disposed on a side far from a free end of the elastic locking piece in the length direction and an operating portion disposed on a side close to the free end when the base is attached to the connector main body, the release lever includes an operated portion disposed on a side far from the free end in the length direction when the base is attached to the connector main body, and a release portion provided so as to be engageable with the free end, and the operated portion is provided in a state of sandwiching the operating portion with an outer surface of the base and in a state of not being physically coupled to the operating portion, and the operating portion moves toward an abutment side with the operated portion through a first see-saw motion of the manipulation lever when the manipulation portion is operated, and the release portion moves the free end in a release direction of the elastic locking piece through a second see-saw motion of the release lever using abutment between the operating portion and the operated portion.

### BRIEF DESCRIPTION OF DRAWINGS

FIG. 1 is a perspective view of a connector device according to a preferred embodiment of the present disclosure when viewed from above;

FIG. 2 is a perspective view of the connector device of FIG. 1 when viewed from below;

FIG. 3 is a side view of the connector device of FIG. 1;

FIG. 4 is a perspective view of a connector member according to a preferred embodiment of the present disclosure when viewed from above;

FIG. 5 is a perspective view of the connector member of FIG. 3 when viewed from below;

FIG. 6 is a view showing a side view of the connector member of FIG. 3 together with a modification of an operating portion upper surface;

FIG. 7 is a side view showing an operation state of the connector device;

FIG. 8 is a perspective view of the connector member before assembly when viewed from the front side;

FIG. 9 is a side view of the connector member of FIG. 8;

FIG. 10 is a front view of the connector member of FIG. 8;

FIG. 11 is a perspective view for explaining an attachment procedure to a cable using a connector member before assembly;

FIG. 12 is a perspective view for explaining the attachment procedure to the cable using the connector member before assembly; and

FIG. 13 is a perspective view for explaining the attachment procedure to the cable using the connector member before assembly.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It is an object of the present disclosure to provide a connector member including an improved unlocking mechanism and a connector device using the connector member.

In order to solve the above problem, a connector member including an unlocking mechanism according to an aspect of the present disclosure includes: a base that is attachable, on one end side in a length direction, to a connector main body having an elastic locking piece for locking, which protrudes in a cantilever shape; a manipulation lever that is pivotally supported on an outer surface of the base in a see-saw movable state and extends in the length direction; and a release lever that is pivotally supported on an outer surface of the base in a see-saw movable state and extends in the length direction, in which the manipulation lever includes a manipulation portion disposed on a side far from a free end of the elastic locking piece in the length direction and an operating portion disposed on a side close to the free end when the base is attached to the connector main body, the release lever includes an operated portion disposed on a side far from the free end in the length direction when the base is attached to the connector main body, and a release portion provided so as to be engageable with the free end, and the operated portion is provided in a state of sandwiching the operating portion with an outer surface of the base and in a state of not being physically coupled to the operating portion, and the operating portion moves toward an abutment side with the operated portion through a first see-saw motion of the manipulation lever when the manipulation portion is operated, and the release portion moves the free end in a release direction of the elastic locking piece through a second see-saw motion of the release lever using abutment between the operating portion and the operated portion.

According to the connector member of this aspect, it is possible to directly relate the operating portion to the operated portion with a simple abutment structure.

### ADVANTAGEOUS EFFECTS OF THE INVENTION

It is possible to provide a connector member including an improved unlocking mechanism and a connector device using the connector member.

In the following, an embodiment according to the present disclosure will be described with reference to the accompanying drawings. Only a preferred embodiment is shown here. However, of course, this is not intended to limit the present disclosure. In the following description, terms (including, for example, "upper", "lower", "side", and "end") indicating specific directions and positions are used as necessary. However, the use of these terms is intended to facilitate the understanding of the present disclosure with reference to the drawings, and the technical scope of the present disclosure is not limited by the meanings of these terms. The drawings are schematic, and ratios of dimensions and the like do not necessarily match actual ones.

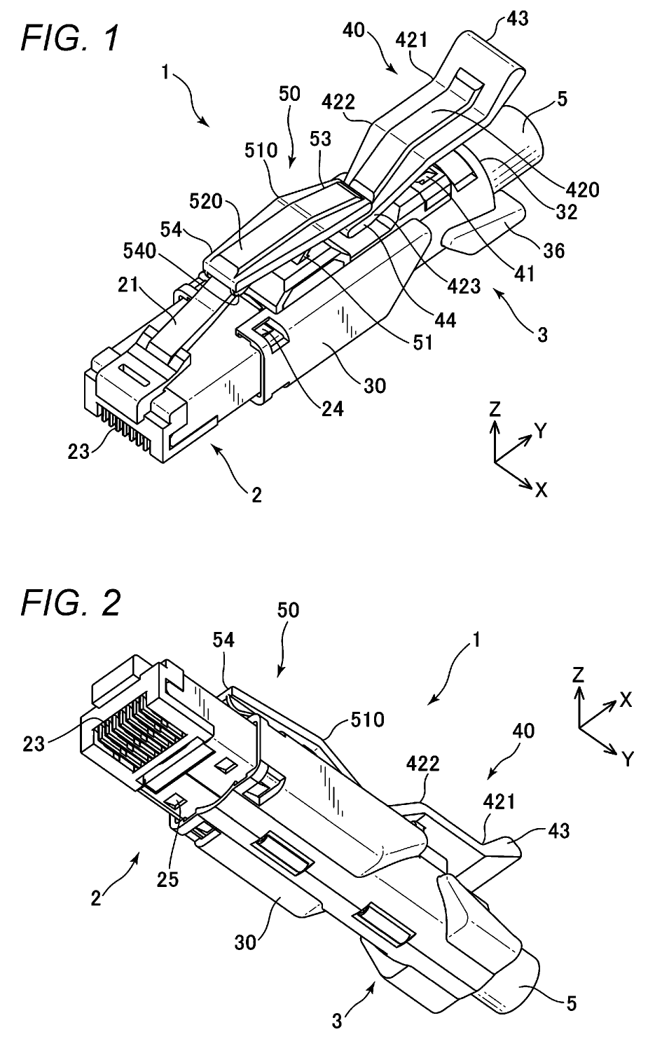

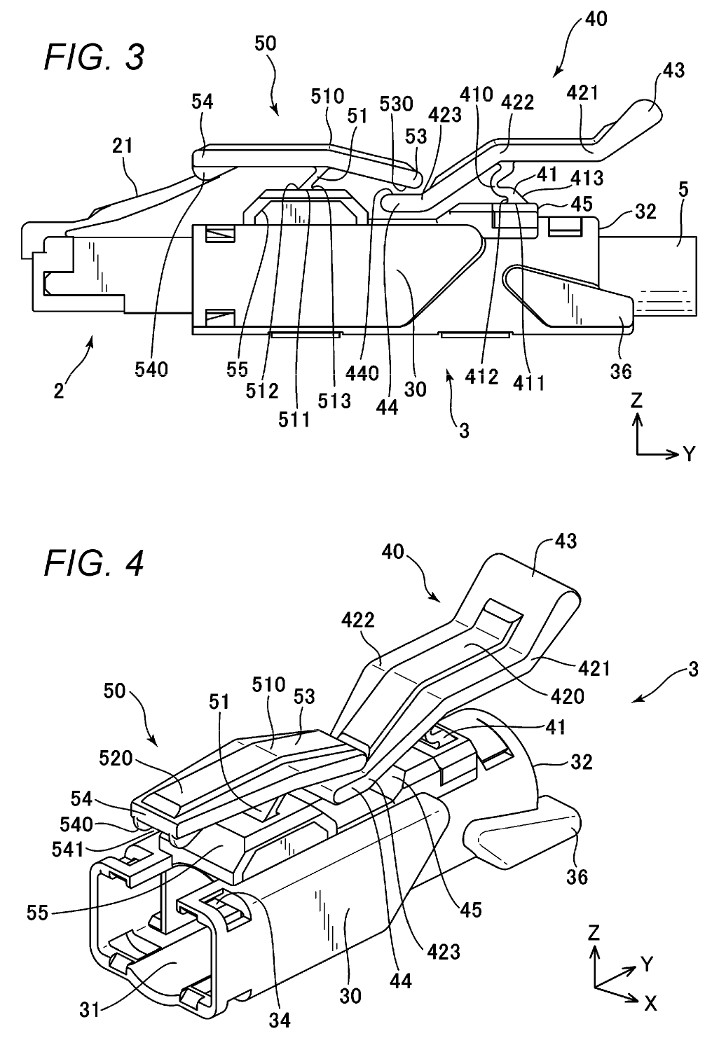

FIG. 1 shows a perspective view of a connector device according to a preferred embodiment of the present disclosure when viewed from above. FIG. 2 shows a perspective view of the connector device when viewed from below. FIG. 3 shows a side view of the connector device.

A connector device 1 includes a connector main body 2 and a connector member 3 according to a preferred embodiment of the present disclosure. The connector main body 2 constitutes a front portion of the connector device 1 in a length direction "Y", while the connector member 3 constitutes a rear portion of the connector device.

The connector main body 2 is a so-called "modular plug connector" and is a connector conforming to RJ45. The connector main body 2 has the same structure and function as the front portion of a normal connector device. The top end side of a cable 5 is accommodated inside the connector main body 2. The rear end side of the cable 5 penetrates the connector main body 2 and the connector member 3 and is then removed to the outside along the length direction "Y" at a removal port 32 at the rear end. On a top-end-side bottom portion of the connector main body 2, a plurality of terminals 23 connected to the cable 5 is arranged along a width direction "X" orthogonal to the length direction "Y" and an elastic locking piece 21 for locking, which protrudes in a cantilever shape toward an oblique rear side is provided on a top-end-side top portion of the connector main body 2. The elastic locking piece 21 is engaged with a part of a receiver that receives the connector device 1 at the time of connection to an electronic device or the like to bring the connector device 1 into a locked state with respect to the receiver, and this locked state can be released by pushing down the elastic locking piece 21 as in a general connector device.

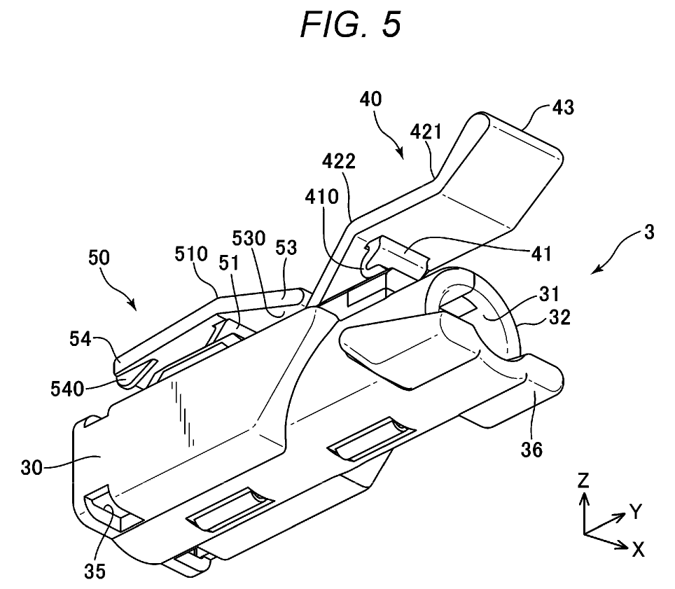

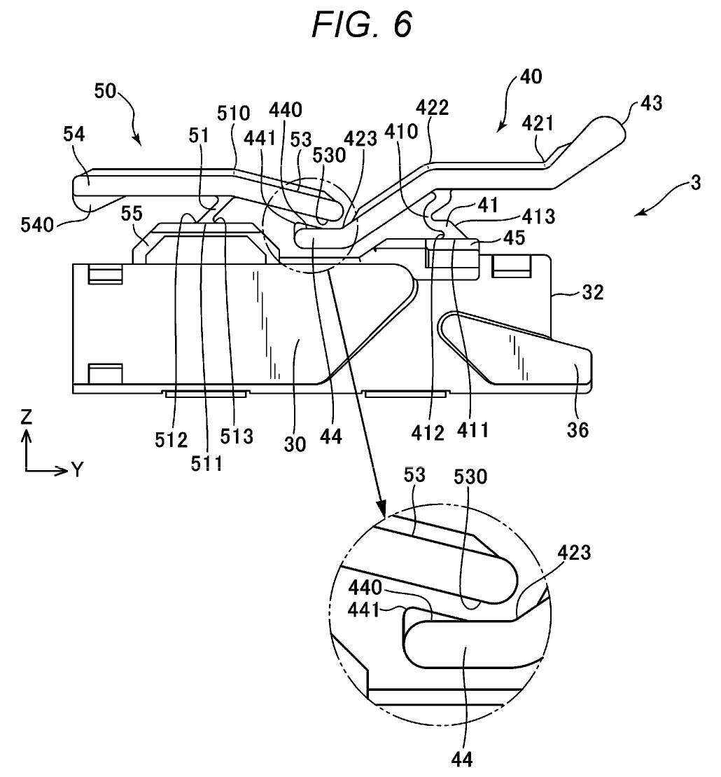

FIGS. 4 to 6 show the connector member 3 shown in FIGS. 1 and 2 as the component drawings. FIG. 4 is a perspective view of the connector member 3 when viewed from above. FIG. 5 is a perspective view of the connector member 3 when viewed from below. FIG. 6 is a side view of the connector member 3. Similarly to the device of EP 4,312,322 A, the connector member 3 includes an unlocking mechanism. More specifically, the connector member 3 includes a mechanism capable of pushing down the elastic locking piece 21 even in a situation where the amount of protrusion of the connector device from the receiver is small and it is difficult to operate the elastic locking piece 21.

The connector member 3 is an integrally molded product of resin. The connector member 3 has a structure that can be assembled as described later. However, in the connector member 3 shown in FIGS. 1 to 6, a state after assembly is shown. The connector member 3 mainly includes a base 30, and a manipulation lever 40 and a release lever 50 attached to the base 30 and extending in the length direction "Y".

The base 30 has a cylindrical accommodation space 31, in which the cable 5 can be accommodated. The accommodation space 31 has a substantially rectangular cross section “X-Z plane” orthogonal to the length direction “Y” along the length direction “Y”. The base 30 is attached to the connector main body 2 on one end side in the length direction "Y". The connector member 3 is provided with a locking hole 34, and the connector main body 2 is provided with a locking projection 24. Note that the terms "length direction", "width direction", and "height direction" in the present specification are terms for distinguishing the three directions, and the technical scope of the present disclosure is not limited to these terms. Therefore, for example, the “length direction” does not necessarily mean longer than the “width direction” and the “height direction”.

The manipulation lever 40 has a substantially rectangular shape in a plan view, and has a plurality of bends 421, 422, and 423 disposed along the length direction "Y" as clearly shown in a side view. The bend 422 located at the center of the manipulation lever 40 is bent so as to protrude upward, while the bends 421 and 423 located at its front and rear are bent so as to protrude downward. Near the center of the upper portion of the manipulation lever 40 in a plan view, a reinforcement rib 420 having a thickness increased in a height direction "Z" orthogonal to the length direction "Y" and the width direction "X" is provided from the bend 421 to the bend 423. By providing the rib 420 and further increasing its thickness, the strength of the manipulation lever 40 can be enhanced. Below the bend 422, a support 41 is provided, which pivotally supports the manipulation lever 40 in a see-saw movable state in a step 45 provided in the base 30.

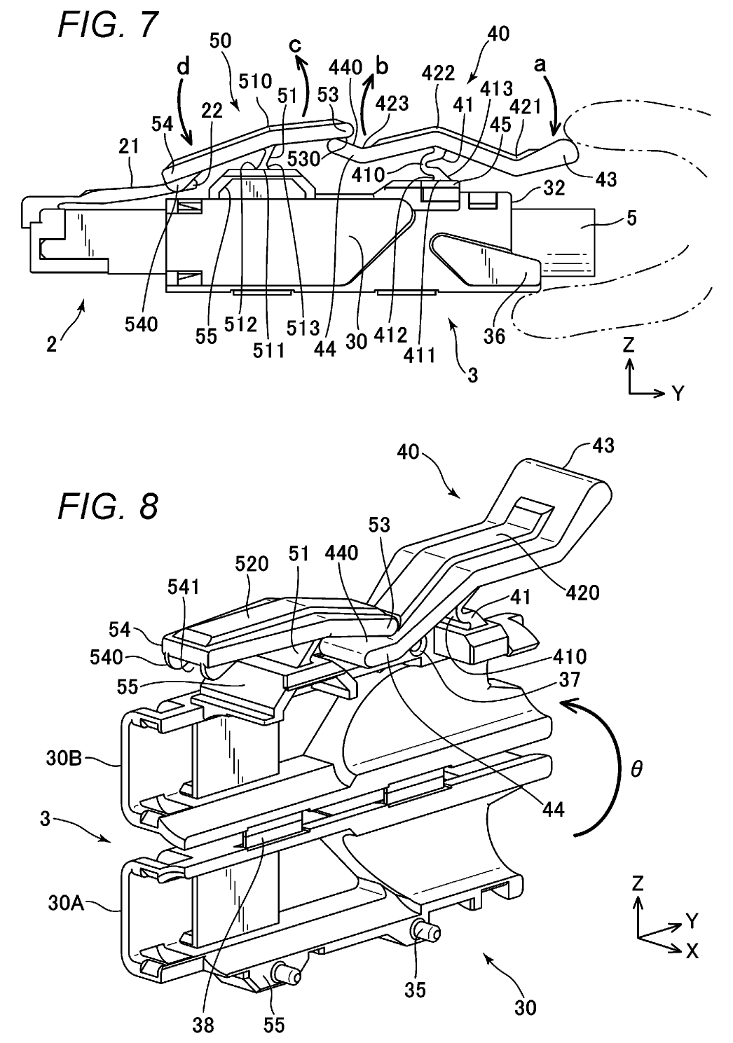

On one end side of the manipulation lever 40, more specifically, on one end side located on a side (rear side) far from a free end 22 of the elastic locking piece 21 in the length direction “Y” when the base 30 is attached to the connector main body 2, a manipulation portion 43 is provided (right side in FIGS. 6 and 7). On the other hand, on the other end side, more specifically, on the other end side positioned on the side (front side) close to the free end 22 of the elastic locking piece 21 in the length direction "Y", an operating portion 44 is provided. Normally, the manipulation lever 40 is elastically held in a forward tilting attitude with respect to the outer surface of the base 30 by the function of the support 41. When the manipulation portion 43 is operated against the elastic force of the support 41, the manipulation portion 43 performs a see-saw motion about the support 41 together with the operating portion 44. More specifically, when the manipulation portion 43 moves in a direction moving away from the base 30, the operating portion 44 moves in a direction approaching the base 30. When the manipulation portion 43 moves in the direction approaching the base 30, the operating portion 44 moves in the direction moving away from the base 30. When the operation of the manipulation portion 43 is stopped, the manipulation lever 40 returns to its original forward tilting attitude due to the function of the support 41.

The support 41 has an elastically curved portion 410 curved in a substantially C shape so as to protrude from the manipulation portion 43 toward the operating portion 44 in the length direction "Y". The surface of a mounting portion 411 of the support 41 with respect to the base 30, specifically its surface on the manipulation portion 43 side, forms an inclined surface 413 inclined substantially linearly so as to approach the base 30 from the operating portion 44 toward the manipulation portion 43 side in the length direction “Y”, while its surface on the operating portion 44 side forms a curved recess 412 curved in a substantially C shape so as to be recessed from the operating portion 44 toward the manipulation portion 43 side. As a result, the surface on the manipulation portion 43 side has a structure that is more easily bent than the surface on the operating portion 44 side. The inclined surface 413 and the curved recess 412 can effectively disperse the force received by the support 41 when the elastically curved portion 410 is curved.

Similarly to the manipulation lever 40, the release lever 50 has a substantially rectangular shape in a plan view, and as clearly shown in a side view, has a bend 510 disposed along the length direction "Y". The bend 510 located at the substantially center is bent so as to protrude upward. Near the center of the upper portion of the release lever 50 in a plan view, a reinforcement rib 520 having a thickness increased in the height direction "Z" is provided from one end to the other end of the release lever 50. By providing the rib 520 and further increasing its thickness, the strength of the release lever 50 can be enhanced. Below the bend 510, a support 51 is provided, which pivotally supports the release lever 50 in a see-saw movable state in a step 55 provided in the base 30.

On one end side of the release lever 50, more specifically, one end side located on a side (rear side) far from the free end 22 in the length direction "Y" when the base 30 is attached to the connector main body 2, an operated portion 53 is provided. On the other hand, on the other end side, more specifically, the other end side positioned on the side (front side) close to the free end 22 of the elastic locking piece 21 in the length direction "Y", a release portion 54 is provided. The operated portion 53 is provided such that a part of an operated portion lower surface 530 and a part of an operating portion upper surface 440 can abut on each other in a state where the operating portion 44 is sandwiched with the outer surface of the base 30 in the height direction "Z". The operating portion upper surface 440 may be provided with a protrusion 441 protruding upward toward the operated portion lower surface 530 (FIG. 6 only shows a partially enlarged view). By providing the protrusion 441, it is possible to adjust the timing of abutment of the operating portion upper surface 440 with respect to the operated portion lower surface 530 when operating the manipulation portion 40. This timing can also be finely adjusted by adjusting the degree of protrusion of the protrusion 441. The operated portion 53 is not physically coupled to the operating portion 44. Therefore, the motion is not performed simply by the motion of the operating portion 44, and the motion is performed only when some force is applied through the abutment with the operating portion 44. Normally, the release lever 50 is elastically held in a slightly backward tilting attitude with respect to the outer surface of the base 30 by the function of the support 51. When a force is applied to the operated portion 53 against the elastic force of the support 51, the operated portion 53 performs a see-saw motion about the support 51 together with the release portion 54. More specifically, when the operated portion 53 moves in a direction moving away from the base 30, the release portion 54 moves in a direction approaching the base 30. When the operated portion 53 moves in the direction approaching the base 30, the release portion 54 moves in the direction moving away from the base 30. When the force is no longer applied to the operated portion 53, the release lever 50 returns to the original backward tilting attitude by the action of the support 51.

The support 51 is inclined in a substantially linear shape so as to approach the base 30 from the operated portion 53 toward the release portion 54 in the length direction "Y". The surface of the mounting portion 511 of the support 51 with respect to the base 30, specifically, its surface on the side of the operated portion 53 forms a curved recess 513 curved in a substantially C shape so as to be recessed from the operated portion 53 toward the release portion 54 side, while its surface on the side of the release portion 54 forms an inclined surface 512 inclined substantially linearly so as to approach the base 30 from the operated portion 53 toward the release portion 54 side in the length direction "Y". As a result, the surface on the operated portion 53 side has a structure that is more easily bent than the surface on the release portion 54 side. The force received by the support 51 can be appropriately dispersed by the inclined surface 413 and the curved recess 513.

FIGS. 1 to 6 show a non-operation state in which the manipulation lever 40 is not yet operated. At this time, the manipulation portion 43 of the manipulation lever 40 is positioned at a position away from the base 30, the operating portion 44 is positioned at a position close to the base 30, the operated portion 53 of the release lever 50 is positioned at a position close to the base 30, and the release portion 54 is positioned at a position away from the base 30.

FIG. 7 is a side view similar to FIG. 3, showing an operation state of the connector device. In contrast to the non-operation state shown in FIGS. 1 to 6, in the operation state shown in FIG. 7, the manipulation portion 43 is pushed down in an "a" direction to be positioned at a position close to the base 30, and in response to this, the operating portion 44 is pushed up in a "b" direction toward the abutment side with the operated portion 53 through the first see-saw motion by the manipulation lever 40 to be positioned at a position away from the base 30. At this time, the operated portion 53 is pushed up in a "c" direction using the abutment between the operating portion 44 and the operated portion, so that the operated portion 53 is positioned at a position away from the base 30. In response to this, the release portion 54 is pushed down to "d" below through the second see-saw motion by the release lever 50. As a result, the release portion 54 moves the free end 22 in the release direction of the elastic locking piece 21. According to this structure, it is possible to directly relate the operating portion 44 to the operated portion 53 with a simple abutment structure. Furthermore, substantially all the force from the operating portion 44 can be transmitted to the operated portion 53 in the height direction "Z" without being dispersed in the length direction "Y", and thus, the transmission loss of the force is less likely to occur. In the case in which a coupling portion is provided between the operating portion 44 and the operated portion 53, since a force is applied to the coupling portion by repeated use, its durability may be a problem. However, in the abutment structure, such a problem does not have to be considered.

The release portion 54 preferably has a shape to easily engage with the free end 22. For example, the release portion 54 has a grip that grips the free end 22. The grip may be a space 541 formed by two plates 540 sandwiching the free end 22 in the width direction “X”.

In order to reliably operate the manipulation portion 43, it is preferable to provide an extension 36 in the removal port 32 of the cable 5 of the base 30. The extension 36 is provided at the removal port 32 of the cable 5 so as to extend in the length direction, i.e., removal direction, "Y" of the cable 5, such that a part of the cable 5 removed through the removal port 32 can be positioned between the cable 5 and the manipulation portion 43. By providing the extension 36, when the manipulation portion 43 is pushed down in the "a" direction, one finger can be disposed on the manipulation portion 43, and the other finger can be disposed not on the cable 5 in the unstable state but on the extension 36 in the stable state. Therefore, it is possible to easily and reliably apply a force to the manipulation portion 43.

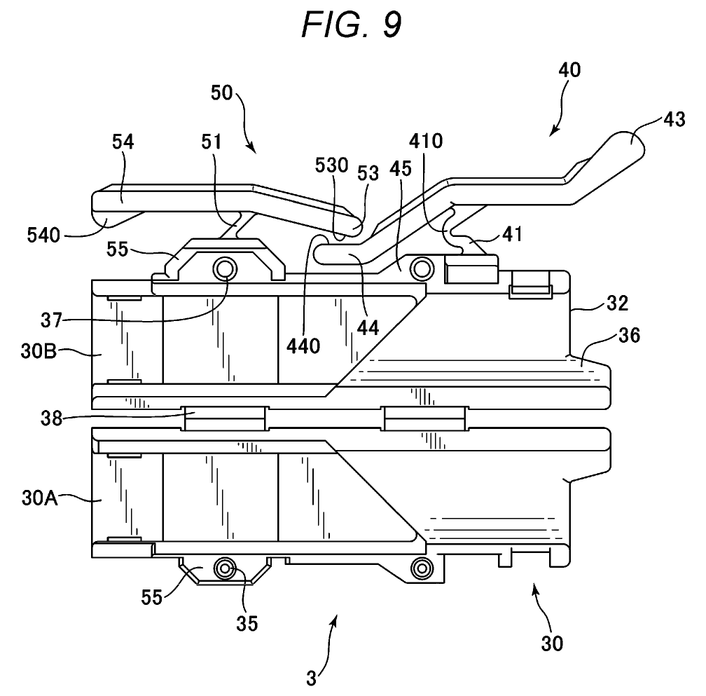

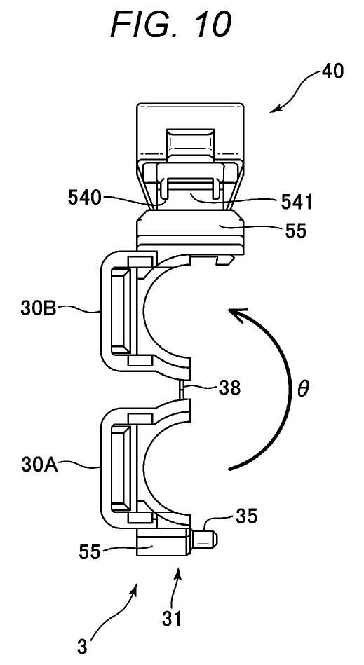

FIGS. 8 to 10 show the state of the connector member 3 before assembly. FIG. 8 is a perspective view of the connector member 3 before assembly when viewed from the front side. FIG. 9 is its side view. FIG. 10 is its front view.

In order to facilitate attachment of the cable, an assembly method is adopted for the connector member 3. In this method, the accommodation space 31 of the cable provided in the base 30 of the connector member 3 is divided into two parts along the length direction "Y" in a cross section "X-Z plane" of the accommodation space 31 orthogonal to the length direction "Y" before assembly. A first base part 30A and a second base part 30B, which are two divided parts, are hinge-connected using a hinge 38, and the first base part 30A is provided with a locking boss 35, and the second base part 30B is provided with a locking hollow 37. The connector member 3 can be easily assembled by rotating the first base part 30A in a "θ" direction toward the second base part 30B about the hinge 38 and locking the locking boss 35 to the locking hollow 37.

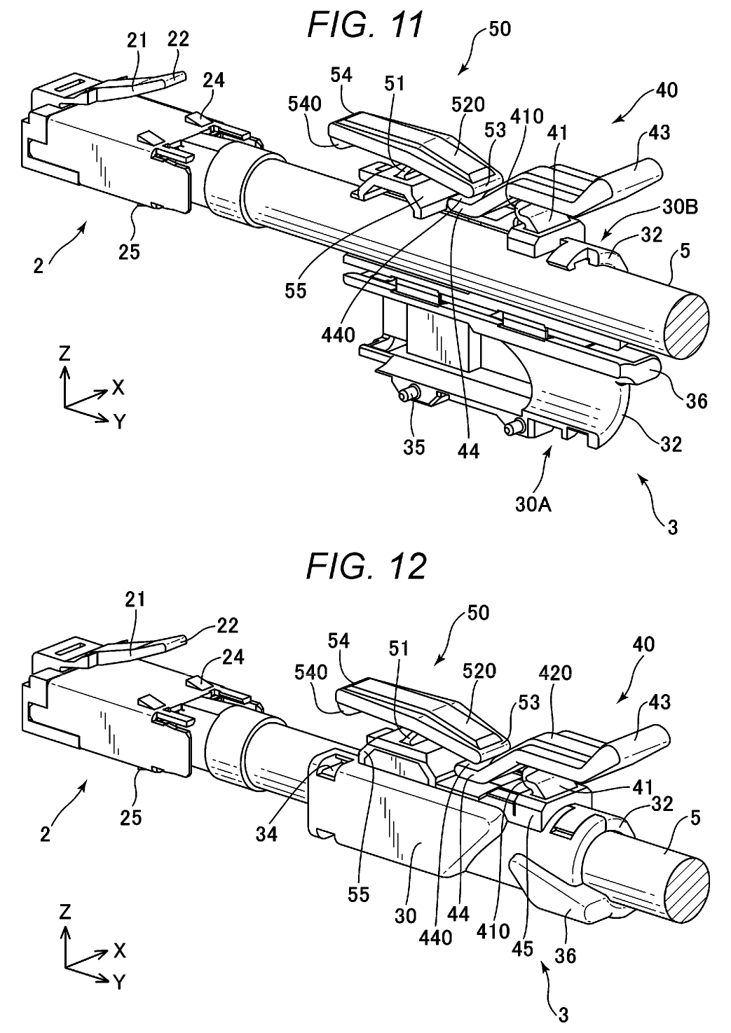

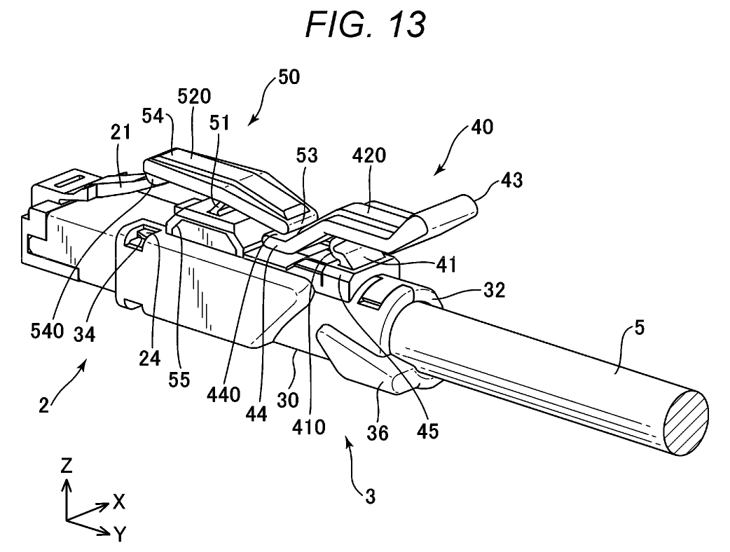

Referring to the perspective views shown in FIGS. 11 to 13, an attachment procedure to the cable 5 using the connector member 3 before assembly shown in FIGS. 8 and 9 will be described. First, as shown in FIG. 11, the intermediate portion of the cable 5, to which the connector main body 2 is attached, is disposed at a predetermined position of the second base part 30B. Subsequently, as shown in FIG. 12, the first base part 30A is rotated with respect to the second base part 30B in a state where the cable 5 is sandwiched, and the first base part 30A and the second base part 30B are fixed using the locking boss 35 and the locking hollow 37. Finally, the connector main body 2 is pulled rearward with respect to the connector member 3 together with the cable 5, and as shown in FIG. 13, the free end 22 of the elastic locking piece 21 provided in the connector main body 2 is positioned below the release portion 54 so as to be sandwiched by the plate 540 in the width direction "X". After that, the locking projection 24 having a triangular shape in a side view and provided in the connector main body 2 is fitted into the locking hole 34 provided in the connector member 3, and thus, the attachment is completed.

The present disclosure is not limited to the embodiment described above, and can be embodied by being appropriately modified without deviating from the gist of the present disclosure. For example, the cable accommodation space 31 provided in the base 30 of the connector member 3 is not necessarily divided into two parts, and may be divided into three or the like. The divided parts of the accommodation space 31 do not necessarily have to be connected by a hinge, and may be separated.

The release lever and the elastic locking piece may be integrated from the beginning.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector member including an unlocking mechanism comprising:
a base that is attachable, on one end side in a length direction, to a connector main body having an elastic locking piece for locking, which protrudes in a cantilever shape;
a manipulation lever that is pivotally supported on an outer surface of the base in a see-saw movable state and extends in the length direction; and
a release lever that is pivotally supported on an outer surface of the base in a see-saw movable state and extends in the length direction, wherein
the manipulation lever includes a manipulation portion disposed on a side far from a free end of the elastic locking piece in the length direction and an operating portion disposed on a side close to the free end when the base is attached to the connector main body,
the release lever includes an operated portion disposed on a side far from the free end in the length direction when the base is attached to the connector main body, and a release portion provided so as to be engageable with the free end, and the operated portion is provided in a state of sandwiching the operating portion with an outer surface of the base and in a state of not being physically coupled to the operating portion, and
the operating portion moves toward an abutment side with the operated portion through a first see-saw motion of the manipulation lever when the manipulation portion is operated, and the release portion moves the free end in a release direction of the elastic locking piece through a second see-saw motion of the release lever using abutment between the operating portion and the operated portion.

2. The connector member according to claim 1, wherein the release portion includes a grip that grips the free end.

3. The connector member according to claim 1, wherein an extension extending in a removal direction of a cable is provided in a removal port of the cable connected to the connector main body, the removal port being provided in the base, such that a part of the cable removed through the removal port is allowed to be positioned between the manipulation portion and the extension.

4. The connector member according to claim 1, wherein the manipulation lever is pivotally supported by a first support on the base, and the first support includes an elastically curved portion curved so as to protrude from the manipulation portion toward the operating portion in the length direction.

5. The connector member according to claim 1, wherein the release lever is pivotally supported by the base by a second support, and the second support is inclined in a substantially linear shape so as to approach the base from the operated portion toward the release portion in the length direction.

6. The connector member according to claim 1, wherein an accommodation space of the base in which the cable is accommodated is divided along the length direction in a cross section of the accommodation space orthogonal to the length direction.

7. The connector member according to claim 1, wherein the manipulation lever includes a reinforcement rib extending along the length direction to increase strength.

8. The connector member according to claim 1, wherein the operating portion of the manipulation lever includes a protrusion configured to adjust an abutment timing with the operated portion of the release lever.

9. The connector member according to claim 1, wherein the base includes an extension provided at a cable removal port and extending in a removal direction of the cable.

10. The connector member according to claim 1, wherein the base includes a first base part and a second base part hinge-connected by a hinge.

11. The connector member according to claim 10, wherein the first base part includes a locking boss and the second base part includes a locking hollow configured to engage with the locking boss.

12. A connector device comprising a modular plug connector that is the connector main body and the connector member according to claim 1.
